(19) United States
(12) Patent Application Publication
(10) Pub. No.: US 2004/0142676 A1
(43) Pub. Date: Jul. 22, 2004

(54) Portable radio module with host adapter

(76) Inventors: Wong Hoo Sim, Singapore (SG); Hiap Chew Chua, Singapore (SG); Kok Ghay Wong, Singapore (SG); Susimin Suprapmo, Singapore (SG)

Correspondence Address: Stephen M. De Klerk, BLAKEY, SOKOLOFF, TAYLOR & ZAFMAN LLP, Seventh Floor, 12400 Wilshire Boulevard, Los Angeles, CA, 90025-1026, US

(21) Appl. No.: 10/382,274

(22) Filed: Mar. 4, 2003

(30) Foreign Application Priority Data
Jan. 21, 2003 (SG) SG 200300160-9

(51) Int. Cl. H04B 1/08

(52) U.S. Cl. 455/351; 455/352; 455/186.1

(57) ABSTRACT

A portable radio module for use with a plurality of different host apparatus, the radio module including a receiver for receiving a radio signal and able to be controlled by a user interface irrespective of the nature of the host apparatus. Also disclosed is a radio module for use with a plurality of host apparatus, the portable radio module including a receiver for receiving a radio signal able to be controlled by a user interface, and having a non-volatile memory for storage at least one radio station memory preset. The radio station memory preset is entered once only by a user and can be used with the host irrespective of the host.

### FIELD OF THE INVENTION

The present invention refers to a portable radio module with host adapter and refers particularly, though not exclusively, to such a radio module for use with a number of different hosts.

### BACKGROUND TO THE INVENTION

Radio receivers have many different forms and sizes—portable radios, “boombox” radios, desktop radios, tuners for use with stereo sets, and so forth. They have different performance characteristics, and user requirements. They also have many technical variations such as, for example, quality of antenna, battery life, acoustic quality, portability, and mobility. Users need to own many radio receivers to enjoy radio reception at work, when travelling, commuting, on vacation, and inside their home. This is not cost effective, and exposes the user to many different user interfaces.

It is the principle object of the invention to provide a portable radio module for use with at least one host apparatus.

### SUMMARY OF THE INVENTION

According to one aspect of the present invention there is provided a portable radio module for use with at least one host apparatus, the radio module including a receiver for receiving at least one radio signal able to be controlled by a user interface irrespective of the nature of the at least one host apparatus.

The at least one radio signal may be supplied to the radio module from the at least one host; the at least one radio signal being of at least one commercially available broadcast radio system using conventional radio frequency (“RF”) modulation techniques such as, for example, frequency modulation (“FM”) and/or amplitude modulation (“AM”). Furthermore, the radio signal may be a local transmission such as, for example, from a user's personal audio device or personal computer that has radio transmission facilities.

The radio may include a non-volatile memory for storage at least one channel memory preset, the at least one channel memory preset preferably needing to be entered by the user once only, and then being usable with the at least one host irrespective of the nature of the host. There may be a predetermined maximum number of preset radio station frequencies.

Each of the preset radio station frequencies may be amended or deleted by the user. Additional preset radio station frequencies up to the predetermined number may be added by the user.

The radio module may include an antenna/headphone socket for receiving therein one of an external antenna and a headphone set. The headphones may have a cable that is also an RF antenna such as an FM antenna.

A power supply to the radio module may be from the at least one host, and the at least one radio signal may be received by a power adapter line of a power adapter of the at least one host.

The radio module may be able to releasably and operatively connect with the at least one host by means of a detachable interface including a connector plug or receptacle forming part of the radio module, and a corresponding connector receptacle or plug forming part of the at least one host. The detachable interface may be a data or networking interface such as a USB or IEEE1394 connector.

The at least one host may be one or more of: an audio device, a portable radio, a portable headphone radio, a conventional headphone, a portable speaker with radio, an audio player, a volume control unit, and a satellite speaker with volume control unit. Preferably, the radio module may be separately used with a number of the hosts without alteration of any preset stations.

The present invention also provides a radio module including a receiver for receiving at least one radio signal and able to be controlled by a user interface, and having a non-volatile memory for storage at least one channel memory preset. In this case, the at least one channel memory preset may be entered once only and may be used with the at least one host irrespective of the host. The at least one host may be one or more of a portable radio, a portable headphone radio, a conventional headphone, a portable speaker with radio, an audio player, a volume control unit, and a satellite speaker with volume control unit. The radio module may be separately used with each of the hosts without alteration of any preset stations.

The radio module thereby forms the core of a radio function.

### DESCRIPTION OF DRAWINGS

In order that the invention maybe readily understood and put into practical effect, there shall now be described by way of non-imitative example only preferred embodiment of the present invention, the description being with reference to the accompanying illustrative drawings, in which:

FIG. 1 is a block diagram of a portable radio with a radio module of the present invention;

FIG. 2 is a block diagram of a portable headphone radio with a radio module of the present invention;

FIG. 3 is a block diagram of a portable speaker with a radio module of the present invention;

FIG. 4 is a block diagram of a desktop audio player with a radio module of the present invention;

FIG. 5 is a block diagram of amplified speaker's wired volume control with radio module of the present invention; and

FIG. 6 is a block diagram of amplified satellite speaker's volume control with radio module of the present invention.

### DESCRIPTION OF PREFERRED EMBODIMENTS

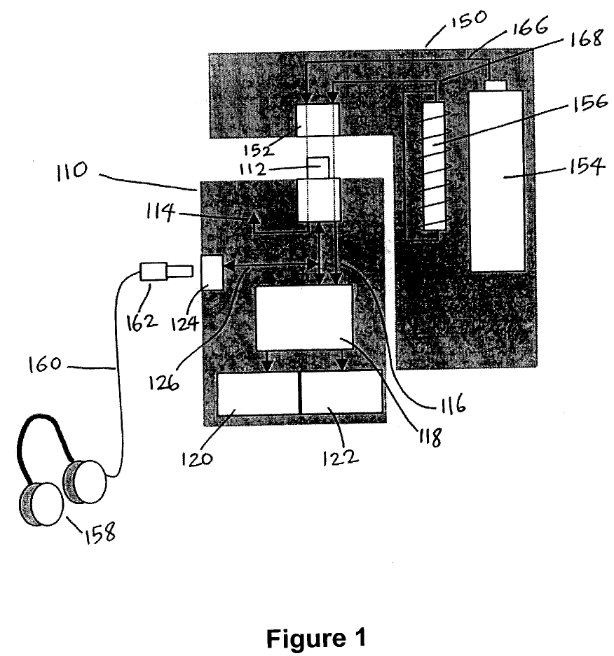

Throughout the drawings there is shown a radio module generally designated as 10 for use with a host generally designated as 50 with, in each instance, a prefix number designating the embodiment and thus drawing figure. For example, in FIG. 1 the radio module is designated 110 and the host as 150.

To first refer to FIG. 1, there is shown a radio module 110 that has a connector plug 112 adapted to releasably engage and cooperate with a connector receptacle 152 in host 150. Connector plug 112 and connector receptacle 152 enable either or both of power from a power source 154 such as a battery, transformer or the like in host 150, and signals from an antenna 156 in host 150, to be passed to radio module 110 via power line 166 and signal line 168 respectively. As the module 10 is a radio module, the antenna 156 is an RF antenna. It may be an AM antenna such as, for example, a ferrite antenna.

The output from connector plug 112 includes a power line 114 to pass the received power to the components of radio module 110. A signal line 116 is used to pass signals received from the antenna 156 to an AM/FM radio receiver 118. The receiver 118 is controlled using a user interface 120.

As users prefer to listen to particular radio stations on a regular basis, several radio stations may be selected and their frequencies held in preset station frequency memory 122. The memory 122 may be a non-volatile memory such as, for example, flash memory, so the preset radio station frequencies need to be input once only and will not require re-entry after radio module 110 is disconnected from receptacle 152 and thus from the power source 154. The preset radio station frequencies may be input by the user using user interface 120. Each preset can be amended or deleted when and as required by the user; or additional preset radio station frequencies can be added by the user when and as required, up to a predetermined maximum number of presets. This may be for example, 10, 20, 50, 100, 1000, or any other suitable number. The predetermined maximum number may be governed by the extend of memory allocated to the preset radio station frequencies. The tuning for the preset frequencies may be digital, or by use of an analog device such as a knob. The radio module 110 retains the preset radio station frequencies in the non-volatile memory 122 and thus the radio module 110 has true portability and mobility. In this way the radio module 110 can be used with a number of different hosts, and still retain the pre-set radio station frequencies.

The radio module may be used with a headphone or other earpiece set 158. The cable 160 of the headphones 158 may also act as an RF antenna such as an FM antenna for radio module 110. The headphones 158 have a jack 162 that connects through a plug 124 to enable the audio signal to be heard by a user, and for the radio signal to be passed to receiver 118 via a radio signal line 126. Line 126 connects plug 124 to receiver 118 and connector plug 112. Line 126 may also be used to pass the audio signal from receiver 118 to headphones 158.

In this way, when radio module 110 is operatively connected to host 150 by plug 112 engaging in receptacle 152, and headphone jack 162 is engaged in plug 124, AM and FM signals, and power, pass to the radio module 110 to enable a user to listen to the radio using headphones 158. In this way the combination of radio module and host 150 are a portable radio.

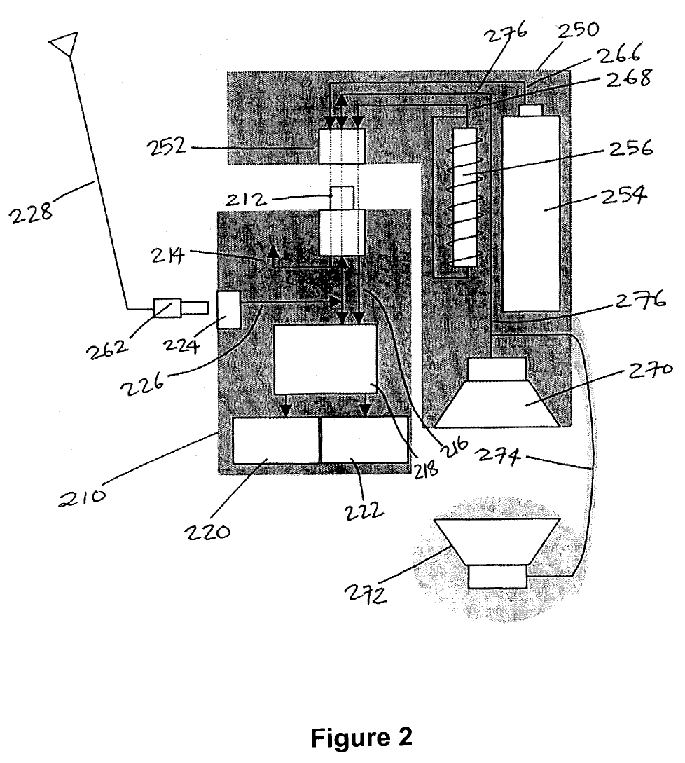

In FIG. 2, the same radio module 210 is used with the same components and functions as are described with reference to FIG. 1. Here, the host 250 is a portable headphone radio having a first, built-in speaker 270 and a satellite speaker 272 connected to first speaker by a speaker cable 274. A speaker line 276 connects first speaker 270 (and thus second speaker 272) to receptacle 252 and thus receiver 218. As there are no headphones an RF antenna such as an FM antenna 228 is connected to plug 224 and thus to receiver 218 by RF such as an FM line 226. Alternatively, the speaker cable 274 can also act as the antenna, the radio signals passing along speaker line 276, receptacle 252, connector plug 212, and signal line 216 to receiver 218. If desired, the speaker cable 274 may be located inside a headband (not shown) of the portable headphone radio. If a mono version, there will be only one speaker 270. This embodiment may be used with conventional headphones having added thereto the receptacle 252, battery 254 and its associated physical connectors and compartment, and antenna built into speaker cable 274.

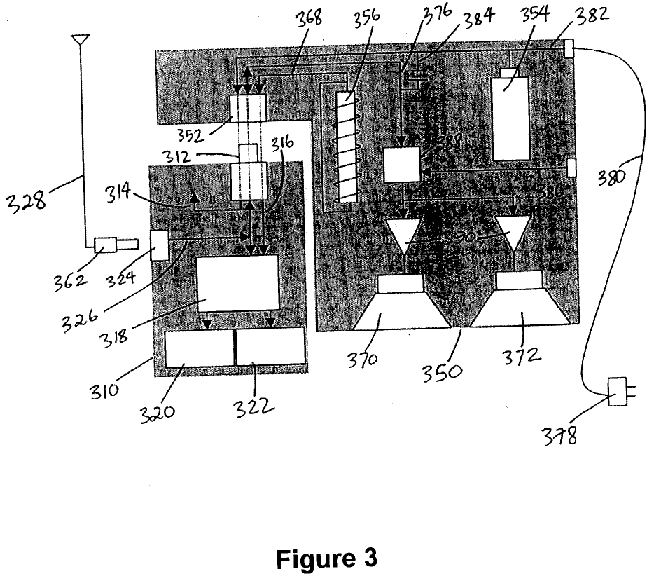

In FIG. 3, there is shown the same radio module 310 as is shown and described in relation to FIG. 2. Again, an external RF such as an FM antenna 328 may be used. Here, the host 350 is a portable speaker that has a battery 354 to power its operation as well as that of the radio module 310 (when fitted). It may also use a power adapter 378 with a power adapter cable 380. If desired, the power adapter cable 380 may include an RF such as an FM antenna. In that case there is provided an input line 382 connected to receptacle 352 and thus to connector plug 312, signal line 316 and receiver 318. An RF coupling 384 is provided between input line 382 and speaker line 376 acting through an audio switch 388. An external line input 386 connected to audio switch 388 is also provided. Each of the speakers 370, 372 may be built-in and each may have its own amplifier 390. If there are any external or satellite speakers, any cable connection can act as the RF antenna.

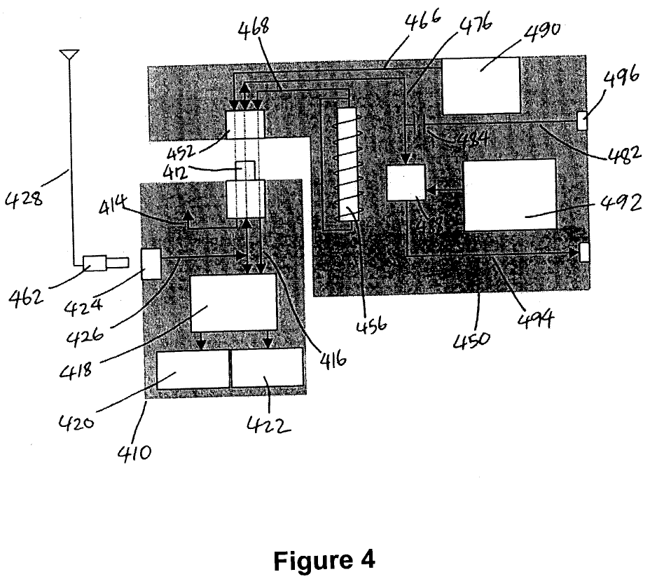

FIG. 4 shows where the host 450 is an audio player. The radio module 410 is the same as described in relation to FIG. 3. The host 450 has a power supply 490 rather than a battery, and has an RF such as an FM coaxial input 496 operatively connected to input line 482. Again, the RF coupling is provided between input line 482 and audio switch 488. In this case audio switch 488 is in-line of an audio line output 494 for having the audio output sent to speakers, amplifier, headphones, or the like. An audio player 492 is also operatively connected to audio switch 488.

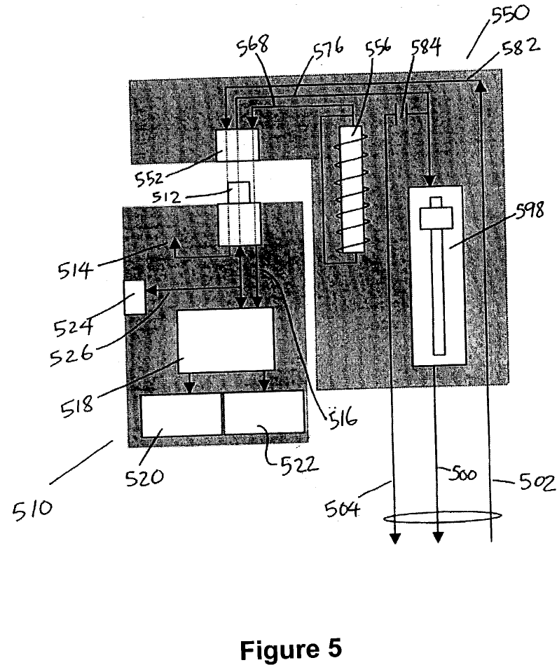

The penultimate embodiment is shown in FIG. 5 where the host 550 is a volume control unit for an amplified speaker system (not shown). The radio module 510 is as described above in relation to FIG. 1. The wired volume cable 504 may have a sleeve that is the RF such as an FM antenna. Power input from the amplified speaker system is via a power input line 502, and audio output from the main volume control 598 is over an audio line 500. The RF coupling is between cable 504, and signal line 576. Signal line 576 carries the radio signal from wired volume cable 504 to receptacle 552.

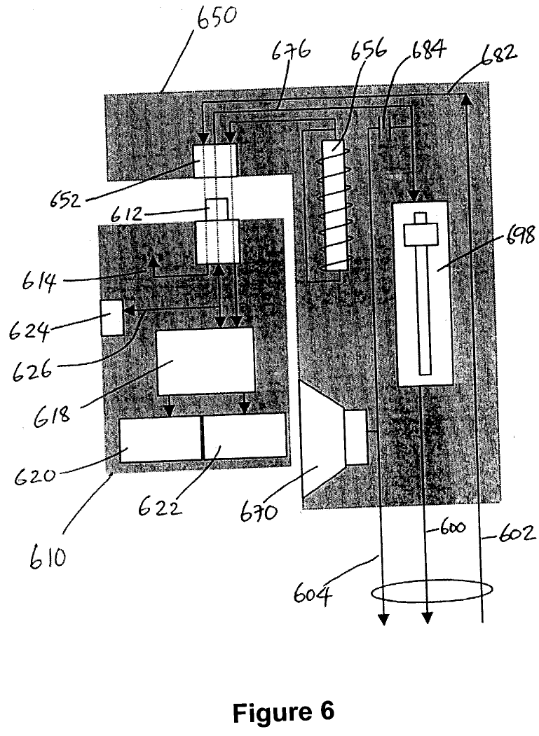

The final embodiment shown in FIG. 6 is the same as for FIG. 5 except that the host 650 is a satellite speaker with a volume control unit built-in. A speaker 670 is provided, and the cable 604 is an audio out cable to other speaker(s). The cable 604 may have a sleeve that is the RF such as an FM antenna. Signal line 676 carries the radio signal from cable 604 to receptacle 652.

Although AM, FM and RF antennas and receivers are shown and described, the present invention can operate with any commercially available radio systems, in any frequency band, and of any appropriate modulation system.

The connector plug 12 and receptacle 52 may be of any suitable mating category able to conduct both power and radio signals including, but not being limited to, data or networking interfaces such as USB or IEEE1394 connectors.

The present invention therefore provides a radio module that is easily transportable (i.e. is quite portable) by a user, and that can be used with different hosts to allow the user to use the radio module with its retained station presets, no matter where they may be house, work, commuting, car, exercising, travelling, and so forth.

Whilst there has been described in the foregoing description preferred embodiments of the present invention, it will be understood by those skilled in the technology concerned that may variations or modifications in details of design or construction may be made without departing from the present invention.

The present invention extends to all features disclosed both individually, and in all possible permutations and combinations.

1. A portable radio module for use with at least one host apparatus, the radio module including a receiver for receiving at least one radio signal and able to be controlled by a user interface irrespective of the nature of the at least one host apparatus.

2. A portable radio module as claimed in claim 1, wherein the at least one radio signal is able to be supplied to the radio module from the at least one host.

3. A portable radio module as claimed in claim 1, wherein the at least one radio signal is able to be supplied to the radio module from an antenna attachable to the radio module.

4. A portable radio module as claimed in claim 1, wherein the at least one radio signal is of at least one commercially available radio system.

5. A portable radio module as claimed in claim 4, wherein the least one radio signal uses conventional radio frequency modulation selected from the group consisting of: frequency modulation, and amplitude modulation.

6. A portable radio module as claimed in claim 1, wherein the at least one radio signal is a local radio transmission from a personal audio device of a user.

7. A portable radio module as claimed in claim 1, wherein there is included a non-volatile memory for storage at least one radio station frequency memory preset up to a predetermined maximum number of preset radio station frequencies.

8. A portable radio module as claimed in claim 7, wherein the at least one radio station frequency memory preset is entered once only by a user and can be used with the at least one host irrespective of the host, and can be amended, deleted or added to by the user.

9. A portable radio module as claimed in claim 1, wherein there is provided an antenna/headphone socket for receiving therein one of an external antenna and a headphone set.

10. A portable radio module as claimed in claim 9, wherein the headphones have a cable that is also an RF antenna such as an FM antenna.

11. A portable radio module as claimed in claim 1, wherein a power supply to the radio module is from the at least one host.

12. A portable radio module as claimed in claim 1, wherein the at least one radio signal is received by a power adapter line of a power adapter of the at least one host.

13. A portable radio module as claimed in claim 1, wherein the radio module is able to releasably and operatively connect with the at least one host by means of a detachable interface including a connector plug forming part of the radio module, and a connector receptacle forming part of the at least one host.

14. A portable radio module as claimed in claim 13, wherein the detachable interface is selected from the group consisting of: USB and IEEE1394 connectors.

15. A portable radio module as claimed in claim 1, wherein the at least one host is one or more selected from the group consisting of: an audio device, a portable radio, a portable headphone radio, a conventional headphone, a portable speaker with radio, an audio player, a volume control unit, and a satellite speaker with volume control unit.

16. A portable radio module as claimed in claim 15, wherein the radio module can be separately used with each of the audio device, portable radio, portable headphone radio, a conventional headphone, portable speaker with radio, audio player, volume control unit, and satellite speaker with volume control unit without alteration of any preset radio station frequencies.

17. A portable radio module for use with at least one host apparatus, the radio module including:
(a) a receiver for receiving at least one radio signal able to be controlled by a user interface, and
(b) a non-volatile memory for storage at least one radio station memory preset, the at least one radio station memory preset being entered once only by a user and can be used with the at least one host irrespective of the host.

18. A portable radio module as claimed in claim 17, wherein the at least one host is one or more selected from the group consisting of: a portable radio, a portable headphone radio, a conventional headphone, a portable speaker with radio, an audio player, a volume control unit, and a satellite speaker with volume control unit.

19. A portable radio module as claimed in claim 18, wherein the radio module can be separately used with each of the portable radio, portable headphone radio, conventional headphone, portable speaker with radio, audio player, volume control unit, and satellite speaker with volume control unit without alteration of any radio station preset.

20. A portable radio module as claimed in claim 17, wherein the at least one station frequency preset in memory can be amended, deleted or added to by the user. 21. A portable radio module for use with at least one host apparatus, the radio module including
(a) a receiver for receiving at least one radio signal and able to be controlled by a user interface irrespective of the nature of the at least one host apparatus;
(b) the at least one radio signal being able to be supplied to the radio module from the at least one host;
(c) a non-volatile memory for storage at least one radio station frequency memory preset up to a predetermined maximum number of preset radio station frequencies, the at least one radio station frequency memory preset being entered once only by a user and being able to be used with the at least one host irrespective of the host, and can be amended, deleted or added to by the user;
(d) an antenna/headphone socket for receiving therein one of an external antenna and a headphone set;
(e) power supply to the radio module being from the at least one host; and wherein
(f) the radio module being able to be releasably and operatively connected with the at least one host by means of a detachable interface including a connector plug forming part of the radio module, and a connector receptacle forming part of the at least one host.
